(19) United States
(12) Patent Application Publication
(10) Pub. No.: US 2015/0257576 A1
(43) Pub. Date: Sep. 17, 2015

(54) WIRELESS COOKING APPLIANCE OPERATED ON AN INDUCTION HEATING COOKTOP

(71) Applicant: ARCELIK ANONIM SIRKETI, Istanbul (TR)

(72) Inventors: Ahmet Yorukoglu, Istanbul (TR); Sefa Cem Hazir, Istanbul (TR); Namik Yilmaz, Istanbul (TR); Hakan Suleyman Yardibi, Istanbul (TR); Onur Yaman, Istanbul (TR)

(21) Appl. No.: 14/435,438

(22) PCT Filed: Oct. 3, 2013
(86) PCT No.: PCT/EP2013/070638

§ 371 Date: Apr. 13, 2015

(30) Foreign Application Priority Data
Oct. 11, 2012 (TR) A 2012/11691

(51) Int. Cl. A47J 27/62; H02J 5/00; H05B 6/12

(52) U.S. Cl. CPC A47J 27/62; H05B 6/1245; H02J 5/005

(57) ABSTRACT

The present invention relates to a cooking appliance (1) suitable to be operated wirelessly on an induction heating cooktop (13) that has one or more than one induction coil (14), comprising a base (2) of ferromagnetic properties, enabling the appliance (1) to be heated from the bottom with the magnetic energy transferred by the induction coil (14), a control unit (3) having a microcontroller providing the controlling of the operating parameters like temperature, motor speed and communication with the cooktop (13) and the monitoring and communication means like the user interface, display, RFID, and a receiver coil (4) that partially receives the power generated by the induction coil (14), providing the required energy for operating the control unit (3) and the additional components like the sensor, mixer motor mounted thereon depending on the intended use of the appliance (1). A printed circuit board (PCB) (6) is disposed between the base (2) and the cooktop (13), comprising at least one substrate layer (5), the receiver coil (4) being printed on the substrate layer (5).

The present invention relates to a cooking appliance operated wirelessly on an induction heating cooktop and which is heated from its base.

The use of kitchen appliances that are operated with the principle of wireless power transmission on the induction heating cooktop is known. Control and communication units like the display, sensor, user interface, RFID, microcontroller are disposed on the wireless kitchen appliances that give “smart” features to these appliances, providing communication with the induction heating cooktop and furthermore providing the monitoring and regulation of the parameters like temperature and motor speed. Low level electrical power is required for energizing the control and communication units. This electrical power is supplied from the induction coil in the induction heating cooktop by means of a receiver coil. The energy required for the control and communication units of the heat controlled cooking appliances, used wirelessly on the induction heating cooktop and having a ferromagnetic base enabling the appliance to be heated from the bottom, is provided with a receiver coil disposed on the base of the cooking appliance and which receives magnetic energy from the induction coil. The receiver coil energizes the control and communication units by partially receiving energy from the induction coil and thus monitoring and adjustment operations can be performed on the cooking appliance. In order for the receiver coil to receive the desired amount of energy from the cooktop induction coil, the receiver coil has to be positioned oppositely (face to face) with the induction coil and near the induction coil. Therefore, the most suitable place for the receiver coil is the base of the cooking appliance that is seated on the induction heating cooktop. The receiver coil, being disposed between the cooktop induction coil and the base of the cooking appliance, partially hinders the energy transfer from the induction coil to the base and heating of the cooking appliance cannot be possible at the power level adjusted by the user in the induction heating cooktop.

The International Patent Application No. WO9941950 relates to a cooking vessel that is used in induction heating cooktops.

The International Patent Application No. WO2010080738 relates to a smart cookware that is wirelessly operated with an inductive power supply.

The U.S. Pat. No. 7,355,150 relates to a cooking appliance that is energized with non-contact power supply.

The aim of the present invention is the realization of a cooking appliance that is operated wirelessly on the induction heating cooktop, having a receiver coil disposed at its base and which is provided to be effectively and homogeneously heated from its base according to the adjusted power level.

The cooking appliance (will be referred to as “appliance” hereinafter) realized in order to attain the aim of the present invention, explicated in the first claim and the respective claims thereof, is a heat controlled appliance like the pot, deep frying pan, soup maker, kettle, coffee machine, tea machine, rice cooker, pasta cooker, pot with a mixer motor, operated wirelessly on an induction heating cooktop (will be referred to as “cooktop” hereinafter).

A control unit is disposed in the appliance, having monitoring and communication means like the microcontroller, user interface, display, RFID which provides the controlling of parameters like temperature, motor speed and communication with the cooktop.

The appliance furthermore comprises a receiver coil in planar spiral form that has one or more than one winding wound with gaps and that partially receives the power generated by the induction coil in the cooktop whereon the appliance is operated and supplies the energy required for operating the control unit and other elements like the temperature sensor, motor, and comprises a printed circuit board (PCB) disposed between the base of the appliance and the cooktop, having at least one substrate layer and wherein the receiver coil is printed on the substrate layer.

In an embodiment of the present invention, the windings of the receiver coil on the printed circuit board of the appliance are spread almost to the entire base area and the appliance is provided to be heated homogeneously from the base with the magnetic energy generated in the induction coil and passing through the winding gaps of the receiver coil.

In another embodiment of the present invention, the printed circuit board has only one substrate layer and the receiver coil is printed on the single surface of the substrate layer facing the base of the appliance or the cooktop.

In another embodiment of the present invention, the printed circuit board has only one substrate layer and a pair of receiver coils is printed on the surfaces of the substrate layer facing the base of the appliance and the cooktop.

In another embodiment of the present invention, the printed circuit board comprises more than one substrate layer and more than one receiver coil printed between the substrate layers.

In another embodiment of the present invention, the printed circuit board is placed into a sleeve produced from silicon and surrounding the bottom and/or top surfaces thereof.

In another embodiment of the present invention, a protective layer produced from glass wool is disposed between the printed circuit board and the base of the appliance.

In another embodiment of the present invention, the printed circuit board is integrated to the base of the appliance, for example, adhered to the base with the sleeve fitted thereon.

In another embodiment of the present invention, the printed circuit board or the printed circuit board inside the sleeve is fixed to the base of the appliance by means of a joining ring.

In another embodiment of the present invention, the printed circuit board comprises a contact extension that provides the electrical connection of the winding terminals of the receiver coil to the control unit.

In the appliance operated wirelessly on the cooktop and heated from the bottom by means of the induction coil in the cooktop and its ferromagnetic base, the receiver coil produced by the printed circuit board production technique is used, the losses in magnetic energy transferred from the induction coil to the base of the appliance are decreased, and the appliance is provided to be heated homogeneously at all power levels whereat the cooktop is operated.

The appliance realized in order to attain the aim of the present invention is illustrated in the attached figures, where:

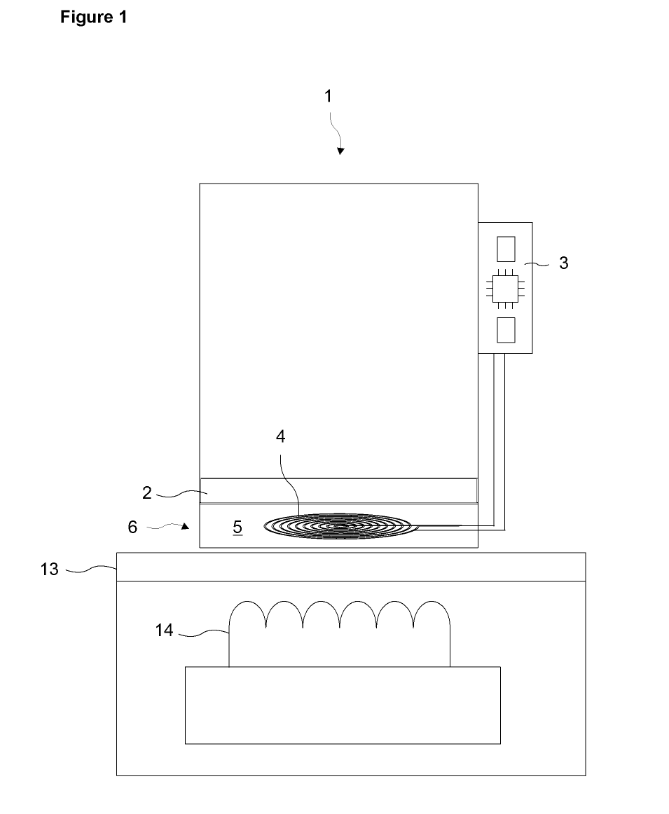

FIG. 1—is the schematic view of the appliance operated on an induction heating cooktop.

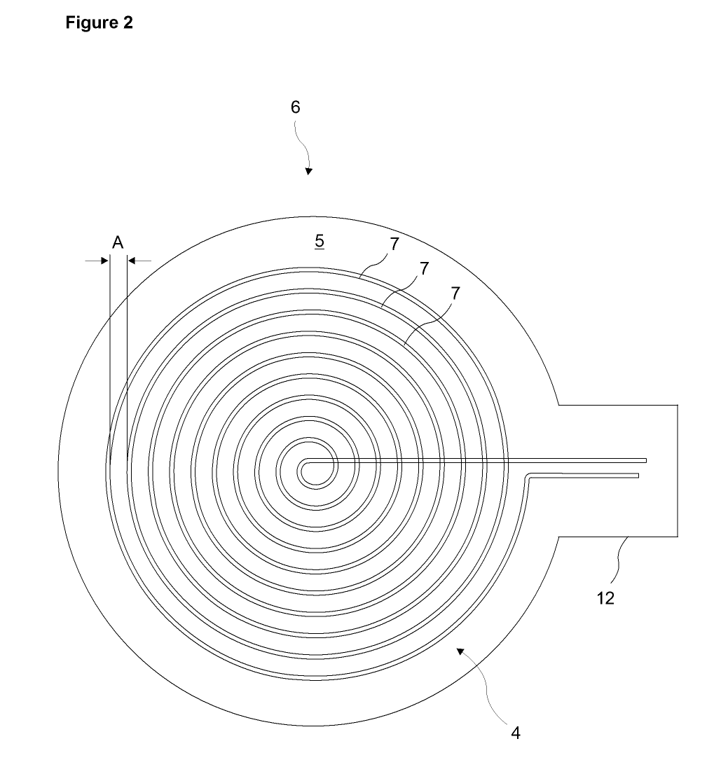

FIG. 2—is the top view of a receiver coil situated on a printed circuit board.

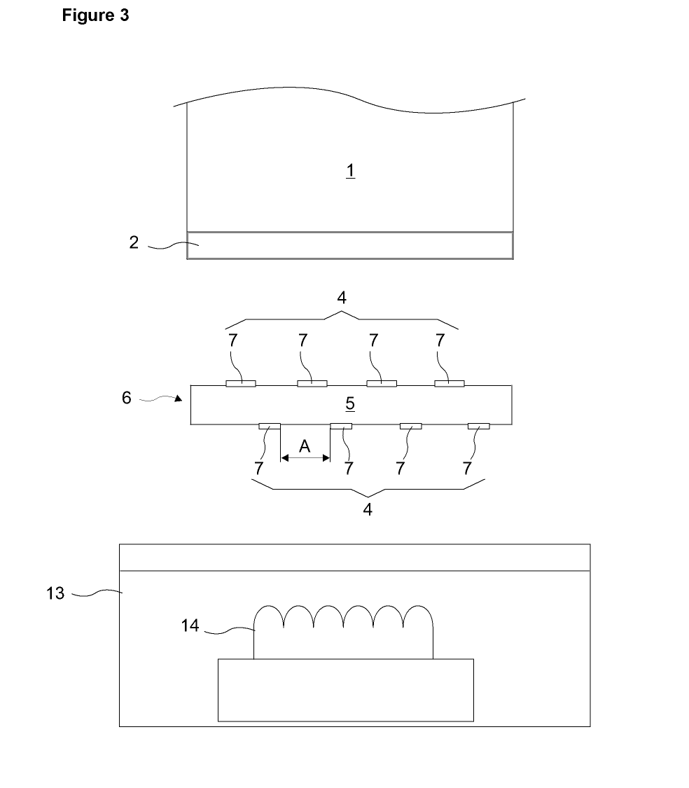

FIG. 3—is the exploded schematic view of the appliance placed on an induction heating cooktop and the printed circuit board.

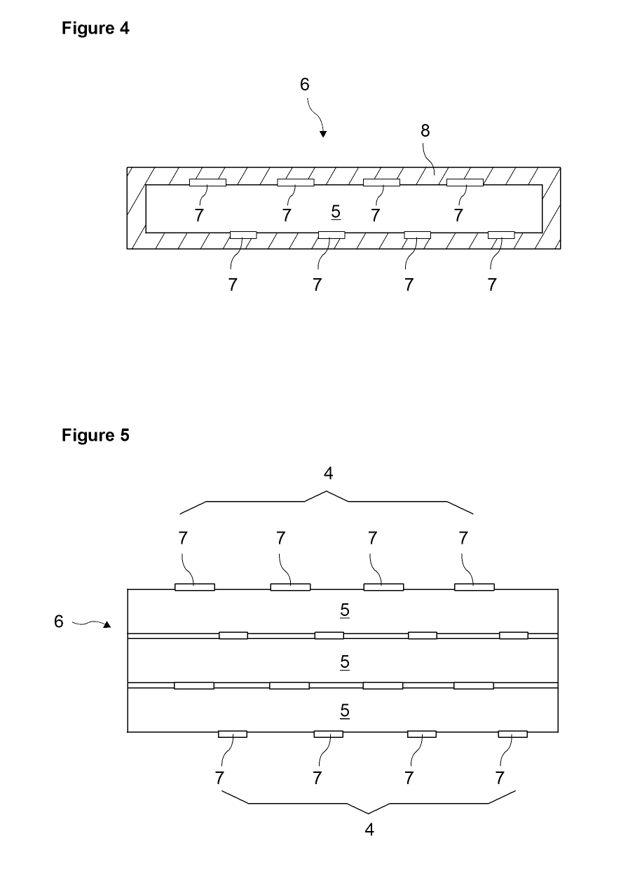

FIG. 4—is the schematic view of a printed circuit board with the sleeve fitted thereon.

FIG. 5—is the schematic view of a multilayered printed circuit board and the receiver coils disposed between the layers.

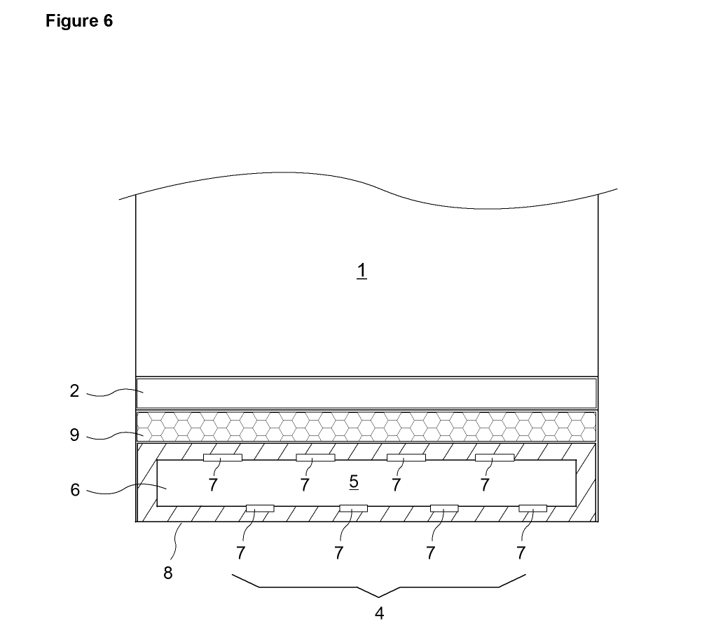

FIG. 6—is the schematic view of an appliance with the printed circuit board integrated to its base in an embodiment of the present invention.

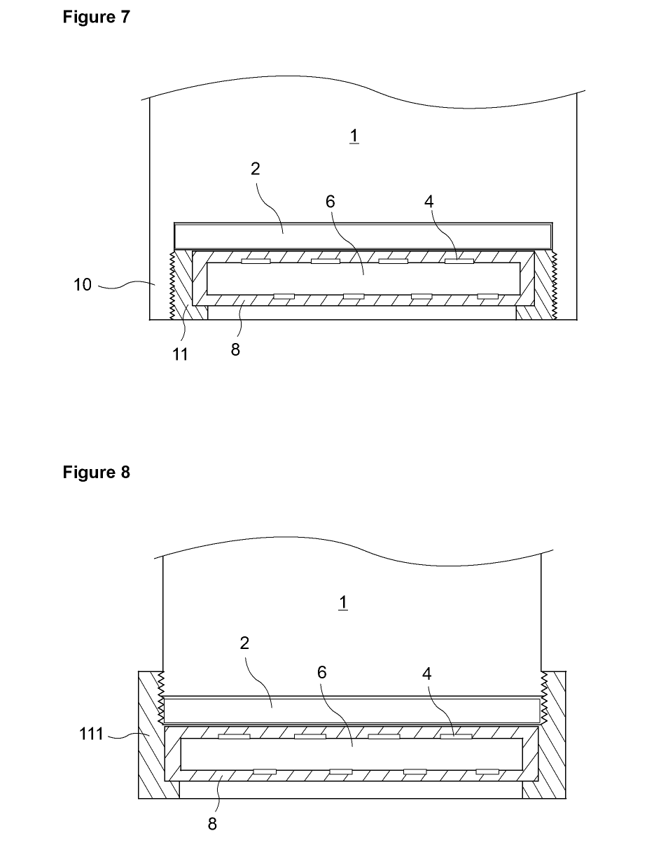

FIG. 7—is the schematic view of an appliance with the printed circuit board integrated to its base in another embodiment of the present invention.

FIG. 8—is the schematic view of an appliance with the printed circuit board integrated to its base in yet another embodiment of the present invention.

The elements illustrated in the figures are numbered as follows:
1. Appliance
2. Base
3. Control unit
4. Receiver coil
5. Substrate layer
6. Printed circuit board
7. Winding
8. Sleeve
9. Protective layer
10. Skirt
11., 111. Joining ring
12. Contact extension
13. Cooktop
14. Induction coil

The cooking appliance (1) (will be referred to as “appliance (1)” hereinafter) suitable to be operated wirelessly on an induction heating cooktop (13) (will be referred to as “cooktop (13)” hereinafter) having one or more than one induction coil (14), comprises a base (2) of ferromagnetic properties, enabling the appliance (1) to be heated from the bottom with the magnetic energy transferred by the induction coil (14), a control unit (3) having a microcontroller providing the controlling of the operating parameters like temperature, motor speed and communication with the cooktop (13) and the monitoring and communication means like the user interface, display, RFID, and furthermore a receiver coil (4) that partially receives the power generated by the induction coil (14), providing the required energy for operating the control unit (3) and the additional components (not shown in the figures) like the sensor, mixer motor mounted on the appliance (1) depending on the intended use thereof.

The appliance (1) of the present invention comprises a printed circuit board (PCB) (6), disposed between the base (2) and the cooktop (13), comprising at least one substrate layer (5), wherein the receiver coil (4) is printed on the substrate layer (5).

In an embodiment of the present invention, the receiver coil (4) comprises one or more than one winding (7) printed in planar spiral form on the substrate layer (5) and made of continuous copper conductive tracks (FIG. 2).

On the substrate layer (5) of the printed circuit board (6) which is produced from non-conductive materials like fiberglass, epoxy, Teflon, polyester compounds, for example FR-1, . . . FR-6, G-10, CEM-1, . . . , CEM-5, the receiver coil (4) formed of thin continuous conductive copper windings (7) is printed in planar spiral form from thin copper plate with the etching, patterning method by using the state of the art printed circuit board (6) (PCB) production technique. The receiver coil (4) provides low voltage, high frequency energy transmission from the induction coil (14) to the control unit (3) of the appliance (1) required for the electronic components like the microcontroller. The receiver coil (4) is also used for relatively higher level energy transmission with respect to the control unit (3), which is required for the mixer motor in appliances (1) having a mixer mechanism. The high amount of magnetic energy required for heating the appliance (1) is provided directly from the induction coil (14) of the cooktop (13) by means of the ferromagnetic base (2). Printed circuit boards (6) of different designs can be used, that are adapted to changing energy transfer conditions between the cooktop (13) and the appliance (1), for example depending on the power level settings in the cooktop (13) and/or the amount of energy required for the electronic equipments in the control unit (3), thereby providing facility of mass production and decreasing the costs. Flexibility is provided in the design of the receiver coil (4) integrated with the printed circuit board (6), and thus the thickness of the copper conductive tracks forming the windings (7) of the receiver coil (4) and the number of windings (7) can be changed. More than one receiver coil (4), one inside the other, side by side or one on top of the other, can be printed on the substrate layer/layers (5) of the printed circuit board (6). The receiver coils (4) can be connected in series or in parallel to one another, and the transferred amount of energy can be adjusted by activating/deactivating one or more than one receiver coil (4) by means of the switching elements disposed on the printed circuit board (6). Since the thickness of the substrate layer (5) of the printed circuit board (6) is quite small, the distance between the base (2) of the appliance (1) and the cooktop (13) is kept at minimum and does not create an obstacle for heating of the appliance (1).

In another embodiment of the present invention, the appliance (1), for being heated according to the power level set in the cooktop (13), comprises the printed circuit board (6) wherein the windings (7) of the receiver coil (4) are printed with gaps (A) therebetween on the substrate layer (5) such that magnetic energy transfer from the induction coil (14) to the base (2) is not hindered (FIG. 2, FIG. 3).

The magnetic energy generated in the induction coil (14) is transferred to the base (2) by passing through the gaps (A) between the windings (7) and the appliance (1) is provided to be heated from the base (2). The receiver coil (4) does not create an obstacle in heating of the appliance (1) by the induction coil (14) by means of the structure of the windings (7) having gaps (A) therebetween. The appliance (1) is away from the cooktop (13), hence from the induction coil (14), only as much as the thickness of the printed circuit board (6), almost the entire amount of the magnetic energy generated by the induction coil (14) is transferred to the base (2) and the appliance (1) is provided to be heated effectively.

In an embodiment of the present invention, the appliance (1) comprises the receiver coil (4) on the printed circuit board (6), having windings (7) that spread almost to the entire area of the base (2). Thus, the receiver coil (4) having the maximum number of windings (7) is obtained, the voltage received from the receiver coil (4) in low power levels of the induction coil (14) is increased and the base (2) is provided to be heated homogeneously.

In an embodiment of the present invention, the appliance (1) comprises the printed circuit board (6) having only one substrate layer (5) and the receiver coil (4) that is printed on the single surface of the substrate layer (5) facing the base (2) or the cooktop (13).

In another embodiment of the present invention, the appliance (1) comprises the printed circuit board (6) having only one substrate layer (5) and two receiver coils (4), connected in parallel or in series to one another, that are printed on the bottom and top surfaces of the substrate layer (5) (FIG. 3).

In another embodiment of the present invention, the appliance (1) comprises the printed circuit board (6) having more than one substrate layer (5) disposed one above the other, and more than one receiver coil (4) printed on the top, bottom and intermediate surfaces of the substrate layers (5) (FIG. 5).

In an embodiment of the present invention, the appliance (1) comprises a sleeve (8) produced from non-conductive material, for example from silicon, which surrounds the lower and/or the upper surfaces of the printed circuit board (6) (FIG. 4). The bare windings (7) extending on the substrate layer (5) of the receiver coil (4) are covered by the sleeve (8) and electrical insulation of the receiver coil (4) is maintained. The windings (7) are prevented from contacting the base (2) and getting short circuited. The user is prevented from contacting the windings (7) in case the receiver coil (4) is on the bottom surface of the substrate layer (5).

In another embodiment of the present invention, the appliance (1) comprises a protective layer (9), produced for example from woven glass, disposed between the printed circuit board (6) and the base (2), providing electrical and thermal insulation. The protective layer (9) protects the printed circuit board (6) from the high heat generated at the base (2).

In another embodiment of the present invention, the appliance (1) comprises the printed circuit board (6), integrated with the base (2), for example fixed to the base (2) together with the sleeve (8) by being adhered.

In another embodiment of the present invention, the appliance (1) comprises a skirt (10) disposed at the lower part of its body, extending below the level of the base (2), surrounding the base (2) and having screw threads on its inner wall and furthermore a joining ring (11) that supports the printed circuit board (6) all around from below, providing the printed circuit board (6) to be mounted to the base (2) by being screwed to the inner wall of the skirt (10) by means of the screw threads on its outer surface (FIG. 7).

In an embodiment of the present invention, the appliance (1) comprises screw threads on its surface surrounding the base (2) below the body and a joining ring (111) supporting the printed circuit board (6) all around from below and which provides the printed circuit board (6) to be mounted to the base (2) by being rotated below the body of the appliance (1) by means of the screw threads on its inner wall (FIG. 8).

In another embodiment of the present invention, the printed circuit board (6) comprises a contact extension (12) extending outwards from the side of the substrate layer (5), whereon the connection elements like the contact pad and/or the connector are placed that provide the electrical connection of the winding (7) terminals of the receiver coil (4) to the control unit (3) (FIG. 2). The winding (7) terminals coming from the receiver coil (4) are connected to the cables (not shown in the figures) coming from the control unit (3) by means of the electrical connection elements (not shown in the figures) like the connector, contact pad which are disposed on the contact extension (12).

The appliance (1) is a heat controlled cooker that requires heating from the base (2) like the pot, deep frying pan, soup maker, kettle, coffee machine, tea machine, rice cooker, pasta cooker, pot with mixer motor.

In the appliance (1) operated wirelessly on the cooktop (13) and which requires heating from the bottom, the losses in magnetic energy transferred from the induction coil (14) to the base (2) of the appliance (1) are decreased and the appliance (1) is provided to heated from the base (2) effectively and homogeneously in all power level settings whereat the cooktop (13) is operated. The windings (7) of the receiver coil (4) are formed on the printed circuit board (6) with the PCB production technique which is suitable for mass production. In the production of the printed circuit board (6), the parameters of the receiver coil (4), like the number of windings (7) and the thickness of the winding (7) wire, can be changed easily. Furthermore, electrical connection elements like the contact pad, connector can also be easily placed on the printed circuit board (6) and ease of production is provided.

1. An appliance (1) suitable to be operated wirelessly on a cooktop (13) having one or more than one induction coil (14), comprising a base (2) of ferromagnetic properties, enabling the appliance (1) to be heated from the bottom with the magnetic energy transferred by the induction coil (14), a control unit (3) having a microcontroller providing the controlling of the operating parameters like temperature, motor speed and communication with the cooktop (13) and the monitoring and communication means like the user interface, display, RFID and a receiver coil (4) that partially receives the power generated by the induction coil (14), providing the required energy for operating the control unit (3) and characterized in that a printed circuit board (PCB) (6) disposed between the base (2) and the cooktop (13), comprising at least one substrate layer (5), the receiver coil (4) being printed on the substrate layer (5).

2. An appliance (1) as in claim 1, characterized in that the receiver coil (4) having one or more than one winding (7) made of continuous copper conductive tracks and printed in planar spiral form on the substrate layer (5).

3. An appliance (1) as in claim 1, characterized in that the printed circuit board (6) whereon the windings (7) of the receiver coil (4) are printed with gaps (A) therebetween on the substrate layer (5) such that magnetic energy transfer from the induction coil (14) to the base (2) is not hindered.

4. An appliance (1) as in claim 1, characterized in that the receiver coil (4) having windings (7) on the printed circuit board (6) that spread almost to the entire area of the base (2).

5. An appliance (1) as in claim 1, characterized in that the printed circuit board (6) having only one substrate layer (5) and in that the receiver coil (4) printed on the single surface of the substrate layer (5) facing the base (2) or the cooktop (13).

6. An appliance (1) as in claim 1, characterized in that the printed circuit board (6) having only one substrate layer (5) and in that two receiver coils (4), connected in parallel or in series to one another, and printed on the bottom and top surfaces of the substrate layer (5).

7. An appliance (1) as in claim 1, characterized in that the printed circuit board (6) having more than one substrate layer (5), disposed one above the other, and in that more than one receiver coil (4) printed on the top, bottom and intermediate surfaces of the substrate layers (5).

8. An appliance (1) as in claim 1, characterized in that a sleeve (8) produced from non-conductive material, which surrounds the lower and/or the upper surfaces of the printed circuit board (6).

9. An appliance (1) as in claim 1, characterized in that a protective layer (9) which is produced from thermally insulating material and disposed between the printed circuit board (6) and the base (2).

10. An appliance (1) as in claim 1, characterized in that the printed circuit board (6) that is integrated with the base (2).

11. An appliance (1) as in claim 10, characterized in that the printed circuit board (6) that is fixed to the base (2) by being adhered.

12. An appliance (1) as in claim 10, characterized in that a skirt (10) extending below the level of the base (2), surrounding the base (2) and having screw threads on its inner wall and in that a joining ring (11) that supports the printed circuit board (6) all around from below, providing the printed circuit board (6) to be mounted to the base (2) by being screwed to the inner wall of the skirt (10) by means of the screw threads on its outer surface.

13. An appliance (1) as in claim 10, characterized in that screw threads on its surface surrounding the base (2) and in that a joining ring (111) supporting the printed circuit board (6) all around from below and providing the printed circuit board (6) to be mounted to the base (2) by being rotated below its body by means of the screw threads on its inner surface.

14. An appliance (1) as in claim 1, characterized in that the printed circuit board (6) comprising a contact extension (12) that provides the electrical connection of the winding (7) terminals of the receiver coil (4) to the control unit (3).

15. An appliance (1) as in claim 1, which is a heat controlled cooker that requires to be heated from the base (2).
